(19) United States
(12) Patent Application Publication
(10) Pub. No.: US 2025/0297883 A1
(43) Pub. Date: Sep. 25, 2025

(54) HIGH-PRECISION LASER SLUDGE LEVEL METER WITH MULTI-POINT MONITORING FUNCTION

(71) Applicant: North China Municipal Engineering Design & Research Institute Co., LTD., Tianjin (CN)

(72) Inventors: Haozheng WANG, Tianjin (CN); Zhiyuan XIE, Tianjin (CN); Fansong WU, Tianjin (CN); Liang ZHANG, Tianjin (CN)

(73) Assignee: North China Municipal Engineering Design & Research Institute Co., LTD., Tianjin (CN)

(21) Appl. No.: 19/229,137

(22) Filed: Jun. 5, 2025

Related U.S. Application Data
(63) Continuation of application No. PCT/CN2024/123865, filed on Oct. 10, 2024.

(30) Foreign Application Priority Data
Apr. 7, 2024 (CN) 202410404513.2

(51) Int. Cl. G01F 23/292; G01F 25/20; G01S 7/481; G01S 7/497; G01S 17/50

(52) U.S. Cl. CPC G01F 23/292; G01F 25/20; G01S 7/4811; G01S 7/4814; G01S 7/497; G01S 17/50; G01S 2007/4977

(57) ABSTRACT

A high-precision laser sludge level meter with a multi-point monitoring function includes a hanging bracket and a measuring structure; the hanging bracket allows horizontal rotation and tilt adjustment to support the measuring structure; the measuring structure includes a housing, and a Doppler optical ranging unit and a gas-liquid drying and flushing unit arranged inside the housing, where the housing is fixed on the hanging bracket, the Doppler optical ranging unit inside the housing is configured to adjust a laser focus through a lens to identify a sludge-water interface in a pipe, and a light output end of the Doppler optical ranging unit is dried and flushed by the gas-liquid drying and flushing unit. The sludge level meter measures a sludge/water interface position by adjusting a laser focal length and proportionally calculates the sludge thickness in the pipe through the focal length adjustment amount.

### CROSS-REFERENCE TO RELATED APPLICATIONS

This application is a continuation of International Patent Application No. PCT/CN2024/123865 with a filing date of Oct. 10, 2024, designating the United States, now pending, and further claims priority to Chinese Patent Application No. 202410404513.2 with a filing date of Apr. 7, 2024. The content of the aforementioned applications, including any intervening amendments thereto, is incorporated herein by reference.

### TECHNICAL FIELD

The present disclosure relates to the technical field of smart water engineering, and in particular to a high-precision laser sludge level meter with a multi-point monitoring function.

### BACKGROUND

As an important infrastructure construction project in urban development, the drainage pipe network system plays a vital role in collecting and transporting rainwater, domestic sewage, and industrial wastewater. It also bears significant responsibilities in urban water pollution prevention, drainage and flood control, etc. Nearly all issues in the drainage pipe system are closely linked to the flow characteristics in the pipes, that is, the transportation process of water within the pipes. For urban drainage pipelines, due to historical constraints, climate change, and cost considerations, it is impractical to design large-diameter pipes with insignificant siltation. Consequently, siltation in urban drainage pipes is a fact that has existed recently or even for a long time. There are two main reasons for pipe siltation: one is deposition of solid particles carried into drainage pipes by rainwater runoff; and the other is sedimentation of suspended solids in sewage pipelines. Siltation will reduce the pipe capacity, diminishes hydraulic efficiency, and may even lead to blockages. These accumulations pose multifaceted challenges to pipeline operation, maintenance, and overall functionality. Therefore, it is very important to investigate and monitor the siltation of drainage pipes.

The sludge level meter is a monitoring device for sludge level monitoring. Currently, a radar sludge level meter or ultrasonic sludge level meter is widely used in the industry, and is generally used in the clarification tank of sewage treatment plants. The installation point of the device has low environmental interference. The principle is to first set the height of the radar or ultrasonic sludge level meter from the bottom of the tank, and then detect the interface height between sludge and water through radar or ultrasonic, and obtain the sludge level through algorithm calculation. However, this device is not applicable in complex situations such as urban drainage pipes or channels. The water flowing in the drainage pipes will interfere with the radar or ultrasonic sludge level meter, making it difficult to obtain accurate sludge level data. Traditional measurement principles and measurement equipment are difficult to apply to the sludge level monitoring of municipal drainage pipes. Real-time monitoring technology for the sludge levels in drainage networks in China is almost blank, and there is still a lack of effective monitoring measures.

### SUMMARY OF PRESENT INVENTION

The objective of the present disclosure is to overcome the shortcomings of the prior art and provide a high-precision laser sludge level meter with a multi-point monitoring function. Based on a Doppler optical flow rate analyzer, the sludge level meter measures a sludge/water interface position by adjusting a laser focal length, that is, measuring an intersection position of water with a flow rate of N and sludge surface with a flow rate of 0 in the pipe, and proportionally calculates the sludge thickness in the pipe through the focal length adjustment amount, so as to avoid the problem that an existing sludge level meter cannot measure the sludge thickness under the liquid surface in the flowing state. The present disclosure is detailed as follows:

A high-precision laser sludge level meter with a multi-point monitoring function is provided, The sludge level meter includes a hanging bracket and a measuring structure, the hanging bracket is fixedly provided inside an inspection well, and the hanging bracket allows horizontal rotation and tilt adjustment to support the measuring structure;

the measuring structure includes a housing, and a Doppler optical ranging unit and a gas-liquid drying and flushing unit arranged inside the housing, where the housing is fixed on the hanging bracket, the Doppler optical ranging unit inside the housing is configured to adjust a laser focus through a lens to identify a sludge-water interface in a pipe, and a light output end of the Doppler optical ranging unit is dried and flushed by the gas-liquid drying and flushing unit.

Preferably, the Doppler optical ranging unit includes an optical barrel; a laser emitting and receiving apparatus, a stationary convex lens, a movable convex lens, and an external lens of the sludge level meter are sequentially provided in the optical barrel from a light input end to a light output end, and a focusing motor, a focusing gear, a focusing rack rod, a stationary seat and a movable seat are provided in the optical barrel;
the focusing motor is fixed inside the light input end of the optical barrel, and a power output end of the focusing motor is meshed with the focusing rack rod through the focusing gear; the focusing rack rod slides axially and adheres to an inner wall of a curved surface of the optical barrel, and the focusing rack rod includes a middle section that slidably penetrates the stationary seat, and an end fixedly connected to the movable seat;
the stationary convex lens is fixedly connected to the stationary seat, and the movable convex lens is fixedly connected to the movable seat.

Preferably, the gas-liquid drying and flushing unit includes a water flushing system and an air drying system; medium output ends of the water flushing system and the air drying system respectively spray liquid and gas to the external lens of the sludge level meter through independent connecting pipes;
a medium input end of the water flushing system is provided with a booster pump, the booster pump is fixed inside the housing, and the booster pump is communicated with a water filling hole that penetrates through the housing;

The air drying system absorbs heat irradiated from electrical equipment inside the housing and sprays hot air onto the external lens of the sludge level meter for drying and defogging; the air drying system includes an air pump, which is fixed inside the housing of the measuring structure; the air pump includes an inlet end connected to a wraparound exhaust pipe, and an exhaust end connected to a connecting pipe; and an inlet end of the wraparound exhaust pipe is arranged around a periphery of the electrical equipment inside the housing and extracts air with heat irradiated from operation of the equipment.

Preferably, the connecting pipe is internally provided with a pressurizing assembly, the pressurizing assembly includes an inner tube, an outer tube, and a spring piston, where one end of the inner tube is connected to the booster pump or the air pump, and one end of the outer tube is connected to a nozzle; a medium output end of the inner tube extends axially into the outer tube and is radially provided with a plurality of axially spaced pipe through holes, and an internal axial elastic top support of the inner tube is connected to the spring piston that elastically seals the plurality of pipe through holes.

Preferably, the hanging bracket includes a well wall bracket and a measuring structure rack, where the well wall bracket includes one end fixed on an inner wall of the inspection well, and the other end rotatable in a horizontal plane to hang the measuring structure rack, and a bottom of the measuring structure rack allows elevation adjustment in a vertical direction to hang the measuring structure.

Preferably, the well wall bracket includes a stationary plate, a support rod and a stationary disc, where the stationary plate is fixed to the inner wall of the inspection well by an expansion bolt, a plurality of support rods are fixed radially along the inspection well on one side of the stationary plate; and a tail end of the support rod is fixedly connected to the stationary disc in a horizontal posture.

Preferably, the measuring structure rack includes a connecting disc, a turntable, a lateral hanging rod, and a flip hanging plate, where the connecting plate is bolted to the stationary disc of the well wall bracket, and the connecting plate includes an axially hollow center and rotates circumferentially to connect the turntable; a plurality of lateral hanging rods are symmetrically fixed on a bottom surface of the turntable, and the flip hanging plate is rotatably hanged to a bottom of the lateral hanging rod.

Preferably, the lateral hanging rod includes an upper part fixedly provided with a horizontal steering motor, and a lower part rotatably connected to an elevation adjustment gear; a stationary gear is coaxially fixed on a bottom surface of the connecting disc, an optical axis section in a middle of the stationary gear rotates circumferentially and axially limits the hanging turntable, and a tooth section at a bottom of the stationary gear is meshed with a power output end of the horizontal steering motor; a tripod head is provided on each of two sides of the flip hanging plate, and the tripod head is meshed with the elevation adjustment gear.

Preferably, a controller, a battery, and an ultrasonic sensor are further provided inside the housing; the controller is electrically connected to the ultrasonic sensor, the hanging bracket, the Doppler optical ranging unit, and the gas-liquid drying and flushing unit; the battery is configured to supply power to the controller, the ultrasonic sensor, the hanging bracket, the Doppler optical ranging unit, and the gas-liquid drying and flushing unit.

Advantages and technical effects of the present disclosure:
(1) The high-precision laser sludge level meter with a multi-point monitoring function of the present disclosure detects the sludge level of the drainage pipe through laser focus, thus avoiding the interference of the flowing turbid water to the device and achieving high monitoring accuracy;
(2) The high-precision laser sludge level meter with a multi-point monitoring function of the present disclosure can automatically adjust the horizontal rotation angle and vertical inclination angle, and can monitor the sludge levels of multiple points at different heights in the drainage pipe through a laser focus path that is spirally emitted. This offers more monitoring data for the pipeline maintenance department, and thus provides data support for sludge removal and pipeline dredging work;
(3) The high-precision laser sludge level meter with a multi-point monitoring function of the present disclosure has the dual cleaning function of water and air for the lens. The lens is kept clean by flushing with pressurized water and pressurized air in sequence. The laser transmission will not be interfered by sewage even if the present disclosure is used in complex environmental conditions such as drainage pipelines;
(4) The high-precision laser sludge level meter with a multi-point monitoring function of the present disclosure can extract heat generated during operation of the controller and the battery for cleaning, heating, and defogging of the lens. This not only reduces the temperature inside the sludge level meter, but also prevents water mist from appearing on the lens, thus realizing the secondary utilization of energy and low-carbon environmental protection;
(5) The high-precision laser sludge level meter with a multi-point monitoring function of the present disclosure is further provided with the ultrasonic sensor, which can measure the water level in the pipe. This helps the drainage pipeline maintenance department to judge the actual water flow and liquid level in the pipe based on the sludge level. The present disclosure has diverse functions and strong practicality.

### BRIEF DESCRIPTION OF THE DRAWINGS

FIG. 1 is a schematic diagram showing a working state of a sludge level meter according to the present disclosure;

FIG. 2 is a stereoscopic view of the sludge level meter according to the present disclosure;

FIG. 3 is a schematic structural diagram of a connecting pipe of the sludge level meter according to the present disclosure; and

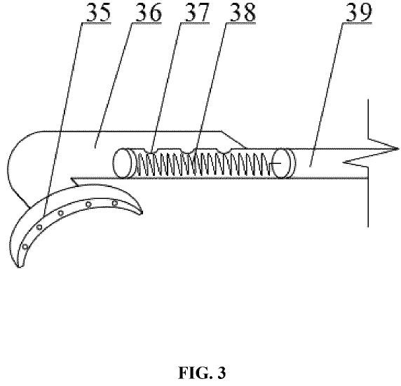

FIG. 4 is a schematic diagram of a ranging principle of a Doppler optical ranging unit in the sludge level meter according to the present disclosure.

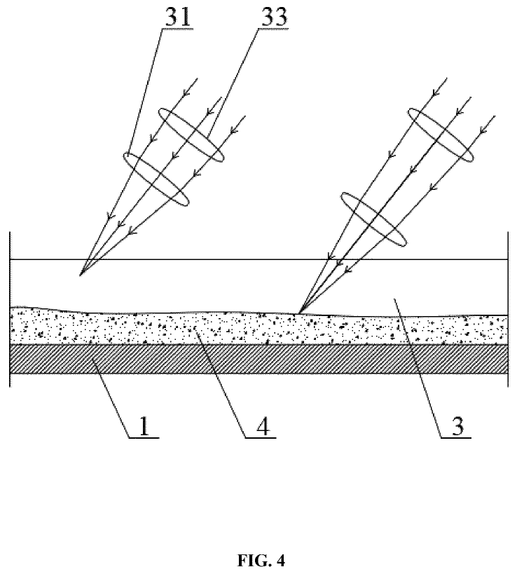

Reference numerals: 1—pipe; 2—laser focus path; 3—fluid in the pipe; 4—sludge in the pipe; 5—measuring structure rack; 6—well wall bracket; 7—measuring structure; 8—stationary disc; 9—connecting disc; 10—stationary gear; 11—horizontal steering motor; 12—turntable; 13—lateral hanging rod; 14—support rod; 15—stationary plate; 16—housing; 17—wraparound exhaust pipe; 18—air pump; 19—tripod head; 20—flip hanging plate; 21—battery; 22—elevation adjustment gear; 23—controller; 24—booster pump; 25—focusing motor; 26—focusing rack rod; 27—ultrasonic sensor; 28—optical barrel; 29—external lens of the sludge level meter; 30—movable seat; 31—movable convex lens; 32—stationary seat; 33—stationary convex lens; 34—laser emitting and receiving apparatus; 35—nozzle; 36—outer tube; 37—pipe through hole; 38—spring piston; 39—inner tube.

### DETAILED DESCRIPTION OF THE EMBODIMENTS

In order to facilitate a further understanding of the content, features and effects of the present disclosure, the present disclosure is described in detail below in conjunction with the embodiments and accompanying drawings. It should be noted that the embodiments are illustrative rather than restrictive, and the protection scope of the present disclosure cannot be limited thereto.

A high-precision laser sludge level meter with a multi-point monitoring function is provided, The sludge level meter includes a hanging bracket and a measuring structure 7, and the hanging bracket is fixedly provided inside an inspection well, and the hanging bracket allows horizontal rotation and tilt adjustment to support the measuring structure.

The measuring structure includes a housing 16, and a Doppler optical ranging unit and a gas-liquid drying and flushing unit arranged inside the housing, where the housing is fixed on the hanging bracket, the Doppler optical ranging unit inside the housing is configured to adjust a laser focus through a lens to identify a sludge-water interface in a pipe 1, and a light output end of the Doppler optical ranging unit is dried and flushed by the gas-liquid drying and flushing unit.

Preferably, the Doppler optical ranging unit includes an optical barrel 28, a laser emitting and receiving apparatus 34, a stationary convex lens 33, a movable convex lens 31, and an external lens 29 of the sludge level meter are sequentially provided in the optical barrel from a light input end to a light output end, and a focusing motor 25, a focusing gear, a focusing rack rod 26, a stationary seat 32 and a movable seat 30 are provided in the optical barrel.

The focusing motor is fixed inside the light input end of the optical barrel, and a power output end of the focusing motor is meshed with the focusing rack rod through the focusing gear; the focusing rack rod slides axially and adheres to an inner wall of a curved surface of the optical barrel, and the focusing rack rod includes a middle section that slidably penetrates the stationary seat, and an end fixedly connected to the movable seat.

The stationary seat is fixedly connected to the stationary convex lens, and the movable seat is fixedly connected to the movable convex lens.

Preferably, the gas-liquid drying and flushing unit includes a water flushing system and an air drying system; medium output ends of the water flushing system and the air drying system respectively spray liquid and gas to the external lens of the sludge level meter through independent connecting pipes.

A medium input end of the water flushing system is provided with a booster pump 24, the booster pump is fixed inside the housing, and the booster pump is connected to a water filling hole that penetrates through the housing.

The air drying system absorbs heat irradiated from electrical equipment inside the housing and sprays hot air onto the external lens of the sludge level meter for drying and defogging; the air drying system includes an air pump 18, which is fixed inside the housing of the measuring structure; the air pump includes an inlet end connected to a wraparound exhaust pipe 17, and an exhaust end connected to a connecting pipe; and an inlet end of the wraparound exhaust pipe is arranged around a periphery of the electrical equipment inside the housing and extracts air with heat irradiated from operation of the equipment.

Preferably, the connecting pipe is internally provided with a pressurizing assembly, the pressurizing assembly includes an inner tube 39, an outer tube 36, and a spring piston 28, where one end of the inner tube is connected to the booster pump or the air pump, and one end of the outer tube is connected to a nozzle 35; a medium output end of the inner tube extends axially into the outer tube and is radially provided with a plurality of axially spaced pipe through holes 37, and an internal axial elastic top support of the inner tube is connected to the spring piston that elastically seals the plurality of pipe through holes.

Preferably, the hanging bracket includes a well wall bracket 6 and a measuring structure rack 5, where the well wall bracket includes one end fixed on an inner wall of the inspection well, and the other end rotatable in a horizontal plane to hang the measuring structure rack, and a bottom of the measuring structure rack allows elevation adjustment in a vertical direction to hang the measuring structure.

Preferably, the well wall bracket includes a stationary plate 15, a support rod 14, and a stationary disc 8, where the stationary plate is fixed to the inner wall of the inspection well by an expansion bolt, a plurality of support rods are fixed radially along the inspection well on one side of the stationary plate; and a tail end of the support rod is fixedly connected to the stationary disc in a horizontal posture.

Preferably, the measuring structure rack includes a connecting disc 9, a turntable 12, a lateral hanging rod 13, and a flip hanging plate 20, where the connecting plate is bolted to the stationary disc of the well wall bracket, and the connecting plate includes an axially hollow center and rotates circumferentially to connect the turntable; a plurality of lateral hanging rods are symmetrically fixed on a bottom surface of the turntable, and the flip hanging plate is rotatably hanged to a bottom of the lateral hanging rod.

Preferably, the lateral hanging rod includes an upper part fixedly provided with a horizontal steering motor 11, and a lower part rotatably connected to an elevation adjustment gear 22; a stationary gear 10 is coaxially fixed on a bottom surface of the connecting disc, an optical axis section in a middle of the stationary gear rotates circumferentially and axially limits the hanging turntable, and a tooth section at a bottom of the stationary gear is meshed with a power output end of the horizontal steering motor; a tripod head 19 is provided on each of two sides of the flip hanging plate, and the tripod head is meshed with the elevation adjustment gear.

Preferably, a controller 23, a battery 21, and an ultrasonic sensor 27 are further provided inside the housing; the controller is electrically connected to the ultrasonic sensor, the hanging bracket, the Doppler optical ranging unit, and the gas-liquid drying and flushing unit; the battery is configured to supply power to the controller, the ultrasonic sensor, the hanging bracket, the Doppler optical ranging unit, and the gas-liquid drying and flushing unit.

In addition, in the present disclosure, preferably, the controller and the laser emitting and receiving apparatus in the Doppler optical ranging unit adopt mature products in the prior art.

A model of the controller is SRC-880.

The laser emitting and receiving apparatus is a Laser Doppler velocimeter (LDA), of a model of MSE-V-ONE, which can implement synchronous, contactless, and real-time measurement for one-dimensional to three-dimensional flow velocity and particle concentration. It can measure the flow velocity of characteristic fluids that flow at supersonic speeds, are almost stationary, or flow in reverse in circulatory turbulence.

In addition, in the present disclosure, preferably, the tripod head is provided on each of two sides of the flip hanging plate adopt mature products in the prior art.

In addition, in the present disclosure, preferably, the ultrasonic sensor is configured to monitor a liquid level in the drainage pipe, and obtain an actual sewage liquid level in the pipe by conversion between the liquid level monitoring data and the sludge level monitoring data.

In order to illustrate the specific embodiments of the present disclosure more clearly, an embodiment is provided below:

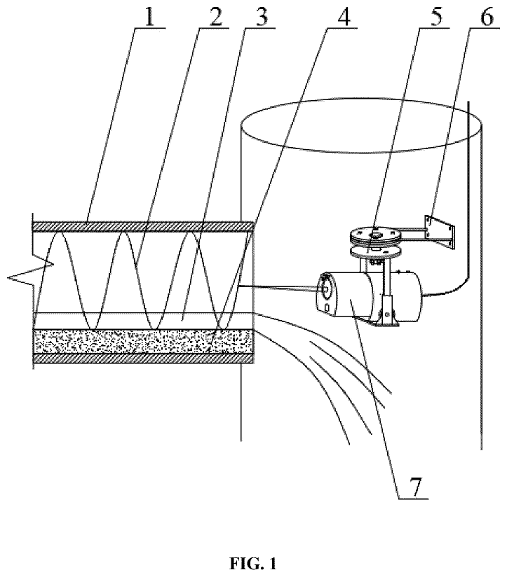

The monitoring principle of the sludge level meter is to utilize the Doppler effect of laser for monitoring. When a laser beam irradiates a moving object, laser light scattered by the moving object produces a Doppler shift. A moving speed of the fluid is determined by monitoring a frequency difference. When the moving speed of the object is 0, that is, when the laser beam irradiates stationary objects such as sludge or pipe walls, the Doppler shift generated by the laser is 0. Components such as the laser emitting and receiving apparatus, the movable convex lens, and the stationary convex lens, etc. can focus the laser onto a predetermined focal point inside the drainage pipe. The laser focus path 2 is shown in FIG. 1. Part of the laser within the focal point of the laser beam is backscattered from the material inside the drainage pipe, returns along the same path as the emitted light, and is focused back into the laser emitting and receiving apparatus. The point for obtaining signal data can be controlled by positioning the laser beam focus. The laser emitting and receiving apparatus is set to receive the laser Doppler signal from only the laser focus area. Finally, the position of the laser focus in the drainage pipe can be controlled by the controller, thereby realizing multi-point sludge level monitoring, as shown in FIG. 1.

The implementation process of the present invention is as follows:

The present disclosure is implemented in a municipal drainage network and is used to monitor information such as sludge level and liquid level of the drainage network.

First, a position for installing the sludge level meter in the drainage pipe network is selected. A section of target points is cleared out, which is a pipe segment having no silt and no sewage. After the pipe is cleared out, in case the sludge level meter is installed at a top of the drainage pipe, firstly, a fixing bolt is inserted into the top of the drainage pipe, and then a level is used to check if the turntable is installed horizontally. Then, the cleaning water tank is filled with clean water through the water filling hole, and a stationary base of the sludge level meter is adjusted to make bubble in the sludge level meter in the center position, thus completing the setting of the initial position of the sludge level meter. The controller is remotely controlled through a power communication cable to set the target points, the horizontal and vertical angles of the sludge level meter are adjusted through the turntable and the flip hanging plate, and the focal point is adjusted through the movable convex lens. The background position information of the cleaned pipe is first monitored to distinguish with the silt without flow rate. After the pipe background data corresponding to all monitoring points are entered, the initial information entry of the pipe is completed. By setting the controller, the cleaning frequency of the nozzle for the external lens of the sludge level meter is controlled. The cleaning method is to first perform pressurized water jet cleaning and then pressurized gas jet cleaning. Batteries or power communication cables are used to provide energy power for the sludge level meter.

In case the sludge level meter is installed on a side wall of the inspection well, a wall stationary plate is first fixed on the side wall of the inspection well through a stationary plate expansion bolt, followed by the same implementation process as the described above.

In addition, in the present disclosure, preferably, the sludge level meter of the present disclosure is particularly suitable for monitoring the sludge level inside pipes in complex environments. On the one hand, the daily humidity inside drainage pipe is high, which can easily form fog; On the other hand, sewage splashes inside the pipe, resulting in light obstruction or refraction on the external lens of the sludge level meter, reducing monitoring accuracy. Therefore, the present disclosure designs a gas-liquid drying and flushing unit, which first uses a water flushing system to perform pulse high-pressure water flushing on the external lens of the sludge level meter, and then uses an air drying system to absorb heat dissipated by the electrical equipment inside the housing, and form high-temperature high-pressure hot air to dry the external lens of the sludge level meter, thereby solving the problem of measurement inaccuracy caused by dirt on the external lens of the sludge level meter.

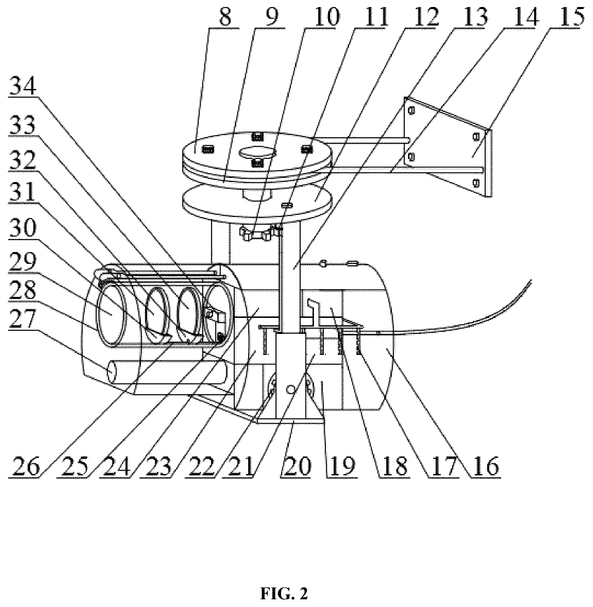

The monitoring method of the present disclosure is as follows:
Step 1: Calibration. A standard pipe is monitored by the sludge level meter, and the standard pipe has a diameter the same as that of an actual pipe to be measured, and the pipe is filled with water but no sludge. The focal path extends axially along the inner wall of the standard pipe to scan an interface between the pipe wall and the water in the standard pipe at different axial positions, and this interface is defined as a standard zero sludge surface. In the monitoring process, the laser focal falls on the intersection of the pipe wall and the fluid 3 in the standard pipe, so as to determine a focal length adjustment amount of the movable convex lens, and the adjustment amount is used as an initial calibration value of 0 thick sludge 4.
Step 2: Single point monitoring. The laser emitting and receiving apparatus emits laser light. The stationary convex lens, the movable convex lens, and the external lens of the sludge level meter transmit focused laser light in sequence. The laser emitting and receiving apparatus collects a light signal reflected by the focus of the focused laser light, so as to determine the fluid flow rate at the focus position. When the fluid flow rate is N (N≠0), it is determined that the focus of the focused laser light is located in the middle of the fluid in the pipe; and when the fluid flow rate is 0, it is determined that the focus of the focused laser light is located at a surface of the sludge in the pipe. By determining the transient state of the pipe flow rate changing from N to 0, the focal length adjustment amount of the movable convex lens is determined, and is compared with the focal length calibration value, thereby calculating the thickness of the sludge in the pipe.
Step 3: With the laser focus path 2 in FIG. 2, the measuring structure is controlled to horizontally twist, vertically flip, and cooperate with the focal length adjustment of the movable convex lens, thereby monitoring the inner wall faults such as pipe silt deposition, pipe damage, pipe indentation and pipe corrosion at multiple points on the inner wall of the entire pipeline along the spiral laser focus path axially distributed.

With the sludge level meter of the present disclosure, sludge level, liquid level, and other information in the municipal drainage piped can be accurately monitored in real time. The sludge level meter is easy to maintain, greatly reducing manual maintenance costs. The data collected by the sludge level meter is substantial and reliable, providing a practical way and method for the planning, construction and maintenance of the municipal drainage system.

Finally, all the parts not described in the present disclosure adopt mature products and mature technical means in the prior art.

It should be understood that those of ordinary skill in the art can make improvements or transformations based on the above description, and all these improvements and transformations should fall within the protection scope of the appended claims of the present disclosure.

What is claimed is:

1. A laser sludge level meter with a multi-point monitoring function, comprising a hanging bracket and a measuring structure, wherein the hanging bracket is fixedly provided inside an inspection well, and the hanging bracket allows horizontal rotation and tilt adjustment to support the measuring structure;
the measuring structure comprises a housing, and a Doppler optical ranging unit and a gas-liquid drying and flushing unit arranged inside the housing, wherein the housing is fixed on the hanging bracket, the Doppler optical ranging unit inside the housing is configured to adjust a laser focus through a lens to identify a sludge-water interface in a pipe, and a light output end of the Doppler optical ranging unit is dried and flushed by the gas-liquid drying and flushing unit;
the Doppler optical ranging unit comprises an optical barrel; a laser emitting and receiving apparatus, a stationary convex lens, a movable convex lens, and an external lens of the sludge level meter are sequentially provided in the optical barrel from a light input end to the light output end, and a focusing motor, a focusing gear, a focusing rack rod, a stationary seat, and a movable seat are provided in the optical barrel;
the focusing motor is fixed inside the light input end of the optical barrel, and a power output end of the focusing motor is meshed with the focusing rack rod through the focusing gear; the focusing rack rod slides axially and adheres to an inner wall of a curved surface of the optical barrel, and the focusing rack rod comprises a middle section that slidably penetrates the stationary seat, and an end fixedly connected to the movable seat;
the stationary convex lens is fixedly connected to the stationary seat, and the movable convex lens is fixedly connected to the movable seat;
the gas-liquid drying and flushing unit comprises a water flushing system and an air drying system; medium output ends of the water flushing system and the air drying system respectively spray liquid and gas to the external lens of the sludge level meter through independent connecting pipes;
a medium input end of the water flushing system is provided with a booster pump, the booster pump is fixed inside the housing, and the booster pump is communicated with a water filling hole that penetrates through the housing;
the air drying system absorbs heat irradiated from electrical equipment inside the housing and sprays hot air onto the external lens of the sludge level meter for drying and defogging; the air drying system comprises an air pump, the air pump is fixed inside the housing of the measuring structure; the air pump comprises an inlet end connected to a wraparound exhaust pipe, and an exhaust end connected to a connecting pipe; and an inlet end of the wraparound exhaust pipe is arranged around a periphery of the electrical equipment inside the housing and extracts air with heat irradiated from operation of the electrical equipment;
the connecting pipe is internally provided with a pressurizing assembly, the pressurizing assembly comprises an inner tube, an outer tube, and a spring piston, wherein one end of the inner tube is connected to the booster pump or the air pump, and one end of the outer tube is connected to a nozzle; a medium output end of the inner tube extends axially into the outer tube and is radially provided with a plurality of axially spaced pipe through holes, and an internal axial elastic top support of the inner tube is connected to the spring piston that elastically seals the plurality of pipe through holes;
the hanging bracket comprises a well wall bracket and a measuring structure rack, wherein the well wall bracket comprises one end fixed on an inner wall of the inspection well, and another end rotatable in a horizontal plane to hang the measuring structure rack, and a bottom of the measuring structure rack allows elevation adjustment in a vertical direction to hang the measuring structure;
the well wall bracket comprises a stationary plate, a support rod, and a stationary disc, wherein the stationary plate is fixed to the inner wall of the inspection well by an expansion bolt, a plurality of support rods are fixed radially along the inspection well on one side of the stationary plate; and a tail end of the support rod is fixedly connected to the stationary disc in a horizontal posture;
the measuring structure rack comprises a connecting disc, a turntable, a lateral hanging rod, and a flip hanging plate, wherein the connecting plate is bolted to the stationary disc of the well wall bracket, and the connecting plate comprises an axially hollow center and rotates circumferentially to connect the turntable; a plurality of lateral hanging rods are symmetrically fixed on a bottom surface of the turntable, and the flip hanging plate is rotatably hanged to a bottom of the lateral hanging rod; and
the lateral hanging rod comprises an upper part fixedly provided with a horizontal steering motor, and a lower part rotatably connected to an elevation adjustment gear; a stationary gear is coaxially fixed on a bottom surface of the connecting disc, an optical axis section in a middle of the stationary gear rotates circumferentially and axially limits the hanging turntable, and a tooth section at a bottom of the stationary gear is meshed with a power output end of the horizontal steering motor; a tripod head is provided on each of two sides of the flip hanging plate, and the tripod head is meshed with the elevation adjustment gear.

2. The laser sludge level meter according to claim 1, wherein a controller, a battery, and an ultrasonic sensor are further provided inside the housing; the controller is electrically connected to the ultrasonic sensor, the hanging bracket, the Doppler optical ranging unit, and the gas-liquid drying and flushing unit; and the battery is configured to supply power to the controller, the ultrasonic sensor, the hanging bracket, the Doppler optical ranging unit, and the gas-liquid drying and flushing unit.

3. A method for monitoring a sludge level using the sludge level meter according to claim 1, comprising:
step 1: calibration: monitoring a standard pipe by the sludge level meter, wherein the standard pipe has a diameter identical to that of an actual pipe to be measured, and the standard pipe is filled with water but no sludge; a focal path extends axially along an inner wall of the standard pipe to scan an interface between the pipe wall and the water in the standard pipe at different axial positions, and the interface is defined as a standard zero sludge surface; and in monitoring process, a laser focal falls on an intersection of the pipe wall and the water in the standard pipe, so as to determine a focal length adjustment amount of the movable convex lens, and the adjustment amount is used as an initial calibration value of 0 thick sludge;
step 2: single point monitoring: emitting, by the laser emitting and receiving apparatus, laser light; transmitting, by the stationary convex lens, the movable convex lens, and the external lens of the sludge level meter, focused laser light in sequence; collecting, by the laser emitting and receiving apparatus, a light signal reflected by a focus of the focused laser light; determining a fluid flow rate at a focus position; when the fluid flow rate is N, and N≠0, determining that the focus of the focused laser light is located in a middle of the fluid in the pipe; and when the fluid flow rate is 0, determining that the focus of the focused laser light is located at a surface of the sludge in the pipe; determining the focal length adjustment amount of the movable convex lens by determining a transient state of a flow rate in the pipe changing from N≠0 to N=0, comparing the focal length adjustment amount with a focal length calibration value, thereby calculating a thickness of the sludge in the pipe; and
step 3: during monitoring, allowing the measuring structure to horizontally twist, vertically flip, and cooperate with the focal length adjustment of the movable convex lens, thereby monitoring inner wall faults comprising pipe silt deposition, pipe damage, pipe indentation and pipe corrosion at multiple points on the inner wall of the pipe along a spiral laser focus path axially distributed.
